(19) United States
(12) Patent Application Publication
(10) Pub. No.: US 2004/0103418 A1
(43) Pub. Date: May 27, 2004

(54) Tray-constrained mechanism of optical disk drive

(76) Inventor: Yi-Wei Lu, Taipei (TW)

Correspondence Address: RABIN & BERDO, P.C., Suite 500, 1101 14 Street, N.W., Washington, DC, 20005, US

(21) Appl. No.: 10/699,662

(22) Filed: Nov. 4, 2003

(30) Foreign Application Priority Data
Nov. 22, 2002 (TW) 91218862

(51) Int. Cl. G11B 17/04; G11B 17/03; G11B 33/02

(52) U.S. Cl. 720/611

(57) ABSTRACT

A tray-constrained mechanism of optical disk drive is proposed. This mechanism, consisting of a resilience part, forms an elastic constraint between the resilience part and a lateral wall on the protrusion part of bottom case, in order to constrain a tray and to reduce vibration generated by a spindle motor. Furthermore, because this mechanism contains only one resilience part, it can reduce both material cost and manufacture cost.

### FIELD OF THE INVENTION

The invention relates to a tray-constrained mechanism of an optical disk drive, particularly to a tray-constrained mechanism that uses a single resilient part fastening to an extension of the tray frame to form an elastic constraint with the lateral wall of a protrusion part of the bottom case of the optical disk drive.

### BACKGROUND OF THE INVENTION

The conventional optical disk drive as shown in FIG. 1 mainly includes a shell that consists of an upper case 1, a bottom case 2, a tray 3, a face panel 5, and a tray frame extension 6. The tray 3 is located between the upper case 1 and the bottom case 2, and may be slid in and out along a channel rail 4. The face panel 5 is located outside the tray 3. The tray frame extension 6 is located on one end of the tray 3.

The optical disk drive further has a spindle motor 3a, which rotates at high speed. Vibration often occurs to the tray 3 and the bottom case 2. The vibration affects the reading accuracy of the optical pick-up head. The effect of vibration is especially annoying while using digital video and audio optical disk drives. Thus a tray-constrained mechanism is usually provided to reduce the vibration range.

The conventional tray-constrained mechanism (referring to FIG. 2) generally includes a circular bucking member 12 on one side of the tray frame extension 6, a connection member 13 and a spring 14. The circular bucking member 12 presses a latch section 11alocated on a lateral wall 11 of a protrusion part of the bottom case. The tray-constrained mechanism reduces the vibration generated by the spindle motor 3a of the optical disk drive. However, in practice such a tray-constrained mechanism still has drawbacks, notably:

1. The tray-constrained mechanism and the tray frame extension 6 of the conventional optical disk drive have complex structures. They require at least three elements, thus the cost is higher.

2. Manufacturing of the tray-constrained mechanism and the tray frame extension 6 of the conventional optical disk drive is time-consuming. This results in higher manufacture cost.

### SUMMARY OF THE INVENTION

In view of the aforesaid disadvantages, the primary object of the invention is to provide a tray-constrained mechanism for optical disk drives that requires only one resilient part to form an elastic buffer and constraint effect. Thereby, to reduce the vibration generated by the rotation of the spindle motor. In one aspect, the resilient part is bucking on a selected location of the lateral wall of a protrusion part of the bottom case of the tray when the tray is retracted to form a steady buffer for reducing vibration. Thus the optical disk drive may operate steadily in a constrained condition. The costs are lower and manufacturing is easier. The structure also is simpler. Element numbers can be greatly reduced to lower the costs of material and manufacturing, and product competitiveness increases.

In order to achieve the aforesaid object, the tray-constrained mechanism for optical disk drives according to the invention includes an anchor end, a fulcrum, an carved out opening and a resilient part. The anchor end is located on one side of a tray frame extension for fastening a fastening end of the resilient part. The resilient part has an energy storing section bucking on the fulcrum located on a face panel frame of the tray and a bucking end pressing elastically the carved out opening, formed on an outer side of a tray frame extension. The carved out opening allows the bucking end of the resilient part to extend outwards and press a lateral wall of a protrusion part of the bottom case to form a buffer, to reduce vibration.

The foregoing, as well as additional objects, features and advantages of the invention will be more readily apparent from the following detailed description, which proceeds with reference to the accompanying drawings. The drawings are only to serve for reference and illustrative purposes, and are not intended to limit the scope of the invention.

### BRIEF DESCRIPTION OF THE DRAWINGS

FIG. 1 is a schematic view of the structure of a conventional optical disk drive.

FIG. 2 is a schematic view of a conventional tray-constrained mechanism.

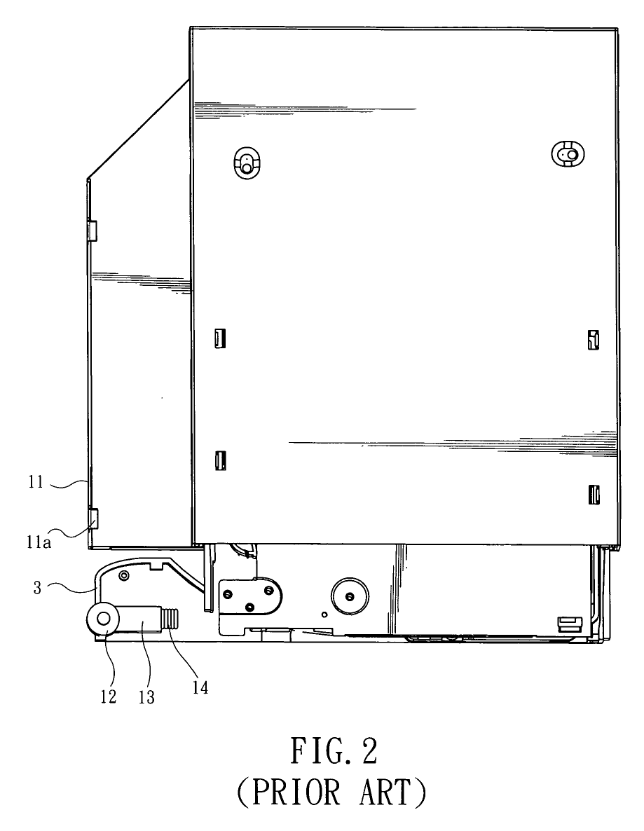

FIG. 3 is a schematic view of an embodiment of the invention.

FIG. 4 is a schematic view of an embodiment of the resilient part of the invention.

### DESCRIPTION OF THE PREFERRED EMBODIMENT

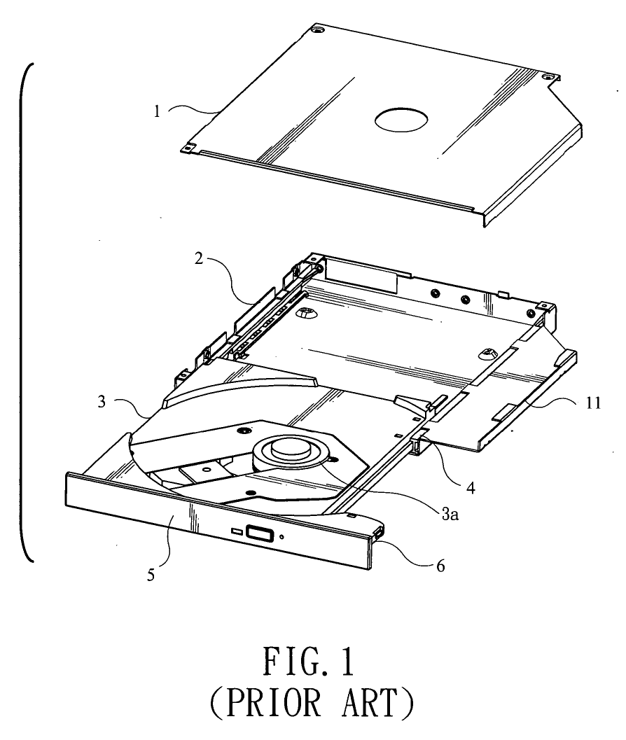

The tray-constrained mechanism for optical disk drives according to the invention is adopted for use on optical disk drives. The optical disk drives generally are constructed like the one shown in FIG. 1, details are omitted herein.

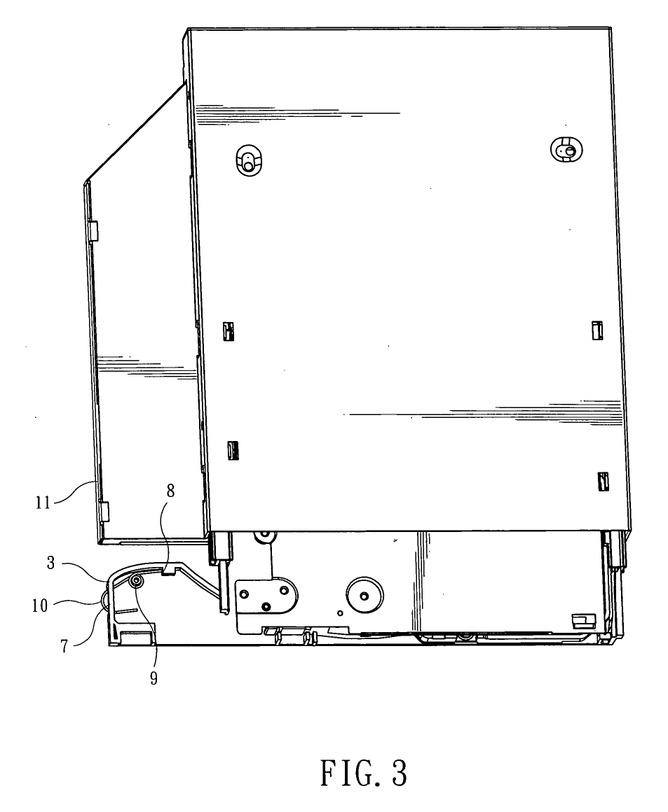

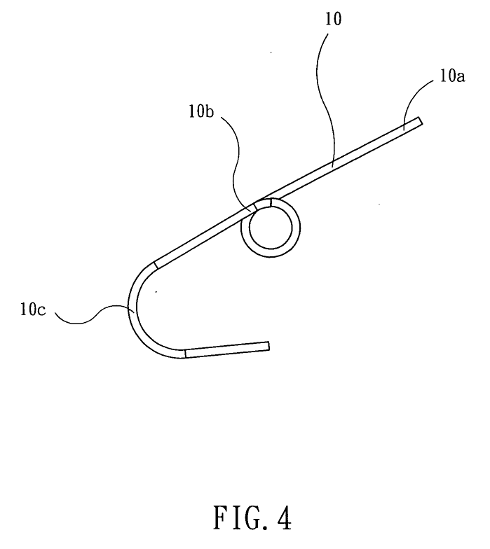

Referring to FIGS. 3 and 4, the tray-constrained mechanism according to the invention includes a resilient part 10 and a lateral wall 11 of a protrusion part of a bottom case of an optical disk drive. The resilient part is formed from a cylindrical or sheet material. There is a tray frame extension 6 which has one side forming a retaining section 8. The tray frame extension 6 has a carved out opening 7 on another side which is on the same side of the lateral wall 11 of the protrusion part of the bottom case. The lateral wall 11 has a carved out opening 7. A fulcrum 9 is located between the retaining section 8 and the carved out opening 7. The resilient part 10 has a fastening end 10afastening to the retaining section 8. Further, an energy storing section 10b bucking on the fulcrum 9 on the frame of a face panel 5, and a bucking end 10c extending outside the carved out opening 7 to press elastically the lateral wall 11 of the protrusion part of the bottom case to form a steady buffer to reduce vibration.

The invention employs a single resilient part 10 and the lateral wall 11 of the protrusion part of the bottom case to form the tray-constrained mechanism to achieve a vibration reducing effect. Thereby, the optical disk drive can operate steadily and maintain an optimum condition at high rotation speed. As the tray-constrained mechanism of the invention requires only one resilient part 10 to accomplish an vibration reducing effect and steady operation, it greatly reduces part numbers. The circular bucking element and connection member used in the conventional structure may be omitted. The manufacturing process is simplified. The costs of material and manufacturing are lower. Production costs decrease-significantly. And product competitiveness increases.

In short, the invention eliminates the circular bucking element and connection member used in the conventional structure, simplifies the manufacturing process, and lowers material and manufacturing costs. Production is faster and more efficient. While the preferred embodiments of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What is claimed is:

1. A tray-constrained mechanism of optical disk drive, comprising:
a shell including a upper case and a bottom case;
a tray slidable between the upper case and the bottom case along a channel rail;
a face panel located on an outer side of the tray; and
a tray frame extension located between the tray and the face panel having a retaining section;
wherein the tray frame extension has a tray constrained means which includes a resilient part, the resilient part having one end fastening to the retaining section, an energy storing section bucking on a fulcrum located on a face panel frame, and a bucking end extending outside a carved out opening formed on the tray frame extension to elastically press a lateral wall of a protrusion part of the bottom case to cushion and reduce vibration.

2. The tray-constrained mechanism of claim 1, wherein the resilient part is formed from a cylindrical material.

3. The tray-constrained mechanism of claim 1, wherein the resilient part is formed from a sheet material.
